(19) United States
(12) Patent Application Publication
(10) Pub. No.: US 2010/0276432 A1
(43) Pub. Date: Nov. 4, 2010

(54) NON-STICK COOKWARE

(76) Inventors: Zhongxin Huo, Katy, TX (US); John RATULOWSKI, Edmonton (CA); Wenhua Yang, Katy, TX (US)

Correspondence Address: SHELL OIL COMPANY, P O BOX 2463, HOUSTON, TX, 772522463, US

(21) Appl. No.: 12/685,422

(22) Filed: Jan. 11, 2010

Related U.S. Application Data
(60) Provisional application No. 61/143,991, filed on Jan. 12, 2009.

(51) Int. Cl. A47J 36/04

(52) U.S. Cl. 220/573.2

(57) ABSTRACT

There is disclosed a non-stick cookware apparatus, comprising a cookware article comprising a first material; a coating on the cookware article comprising a second material; wherein the second material comprises a critical surface tension value less than 75 mN/m and a hardness value of at least 5 measured on a Moh's scale.

### RELATED APPLICATIONS

The present application claims priority to co-pending U.S. Provisional application 61/143,991 filed Jan. 12, 2009 which is herein incorporated by reference in its entirety.

### FIELD OF INVENTION

There is disclosed cookware such as pots or pans with an improved non-stick coating.

### BACKGROUND

Cookware such as pots and pans has been coated with PTFE, such as Teflon® brand coatings commercially available from DuPont, to create a non-stick surface. This coating provides for less sticking of the food during cooking, and for easier cleaning of the cookware.

U.S. Pat. No. 6,067,888 discloses a carbide-tipped circular saw blade is formed by brazing cutting tips of tungsten carbide to the teeth of a steel blade blank, thereby creating discoloration on the planar surfaces of the blade adjacent the rim. Substantially the entire surface of the blade is sandblasted with blast media to remove the discoloration while generating a substantially uniform coloration and texture to the planar surfaces of the blade. User-readable graphics are overprinted upon the blasted surface. The graphics and the surface appearance of the blasted area are selected to be at a predetermined contrast, and the carbide cutting tips retain a visual appearance different from the rest of the blade, such that the graphics and cutting tips are visually perceptible to a potential purchaser at the blade's point of sale. The saw blade surfaces are sandblasted by jets directed at both sides of the saw blade. The blast nozzles are oriented such that the vertical components of force of the jets offset one another. This assists in minimizing the blade warping that would otherwise occur due to the sandblasting operation. In all-sandblasted ‘softbody’ blades, a reduction of 20% in deviation from flatness has been achieved compared to similar blades which are polished and rim-blasted. U.S. Pat. No. 6,067,888 is incorporated herein by reference in its entirety.

Japanese Patent Number JP05344927 discloses cooking articles such as a pan, iron pot, and a frying-pan, a TiN mirror surface layer is formed on the inner surface of a pan base member, and an unevenness is formed on the heating bottom surface, and a TiC blackened layer is formed on the unevenness surface. JP 05344927 is incorporated herein by reference in its entirety.

There is a need in the art for non-stick, non-scratch, improved, lower cost, and/or alternative coatings for cookware.

### SUMMARY OF THE INVENTION

One aspect of invention provides a non-stick cookware apparatus, comprising a cookware article comprising a first material; a coating on the cookware article comprising a second material; wherein the second material comprises a critical surface tension value less than 75 mN/m and a hardness value of at least 5 measured on a Moh's scale.

Advantages of the invention include one or more of the following:

Improved non-stick coatings for cookware;

Improved non-scratch coatings for cookware;

Lower cost non-stick coatings for cookware; and/or

Alternative non-stick coatings for cookware.

### BRIEF DESCRIPTION OF THE DRAWINGS

FIG. 1 shows the Zisman plot derived from contact angle measurements of tungsten carbide.

FIG. 2 shows the Zisman plot derived from contact angle measurements of surface Z.

FIG. 3 shows the Zisman plot derived from contact angle measurements of surface TK-2.

FIG. 4 shows the Zisman plot derived from contact angle measurements of surface TK-7.

FIG. 5 shows the Zisman plot derived from contact angle measurements of surface TK-805.

### DETAILED DESCRIPTION

Embodiments disclosed herein are directed to articles of cookware having a surface which is coated with tungsten carbide. In particular, embodiments disclosed herein are directed to the use of tungsten carbide as coatings to make non-sticking and non-scratching articles of cookware.

According to the present disclosure, there is provided an article of cookware having an inner surface coated with tungsten carbide. In one embodiment, the coating is monotungsten carbide, WC. In another embodiment, ditungsten carbide, W₂C, is used. In yet another embodiment, the coatings contain a mixture of tungsten carbides with each other. In yet another embodiment, the coatings contain a mixture of tungsten carbides with tungsten or free carbon.

Tungsten carbide has a critical surface energy γ_{c}, of approximately 20 mN/m. The critical surface tension of a solid surface is an indication of its relative hydrophobic or hydrophilic character. A low critical surface tension means that the surface has a low energy per unit area. The lower the value is for a surface, the more unlikely sticking will occur on such surfaces. The tungsten carbide γ_{c}, value is lower than most commercially available coatings as for example carbon steel (γ_{c}=˜100 mN/m), copper (γ_{c}=˜140 mN/m) and gold (γ_{c}=˜230 mN/m), and comparable to polytetrafluoroethylene (γ_{c}=˜18 mN/m) typically used in cookware applications. At such a surface energy level, a tungsten carbide substrate may generally have a critical surface tension less than most liquids, which are typically greater than 20 mN/m. Thus, so long as the a substrate has a lower critical surface tension than a liquid, solid deposition is unlikely, as such solids may deposit slowly, and if they deposit, removal of such deposits is easier due to the low surface energy level of the tungsten carbide coating. Such tungsten carbide coatings may thus greatly reduce the adherence of food onto articles of cookware, providing benefits both during cooking in that the food does not stick onto the cooking surface, and during cleaning of the cookware after use.

In other embodiments, other carbide coatings may be used alone or in combination with tungsten carbide, for example titanium carbide, tantalum carbide, and/or zirconium cardie.

Moreover, such tungsten carbide coatings may be extremely hard (Moh's hardness of about 9) and wear resistant. Such inherent material properties of tungsten carbide may render the tungsten carbide-coated cookware of the present disclosure scratch-, and/or abrasion-resistant. Such properties may also allow such cookware articles to be washed with any dishwashing means, including dishwashers and steel wool scouring pads, without any concern for their integrity. In comparison, PTFE coatings generally have a Moh's hardness of less than about 3.

The articles of cookware that may be coated with the coatings of the present disclosure may take many forms including pots and pans for stovetop cooking such as a sauce pan, frying pan, wok, and stock pan, bakeware including baking pans, casserole pans, cake pans, and cookie sheets, grills, griddles, or any other food preparation devices, such as crock pots or rice cookers. Such articles of cookware may be formed of a variety of materials known in the art of cookware, such as for example, glass, steel, copper, aluminum, titanium, cast iron, or stainless steel; however, no limitation is intended on the type of material that may be coated with the tungsten carbide coatings of the present disclosure. Further, it is also within the scope of the present disclosure that the substrate material of the cooking articles may be a single layered material or it may be bonded as a clad composite to layers of various other materials such as a conductive core material to promote thermal conductivity. For example, magnetic layers of ferritic stainless steels may also be included in the composite to make the article compatible with induction heating ranges.

In one embodiment, of the present disclosure, the deposited tungsten carbide coating may have a thickness of about 1 to about 20 μm. In another embodiment, the tungsten carbide layer has a thickness of about 2 to about 10 μm.

In one embodiment, the tungsten carbide coating of the present disclosure is applied as a single layer on the substrate material. In another embodiment, the tungsten carbide coating is deposited as multiple layers on the substrate material.

In yet another embodiment of the present disclosure, the substrate to be coated has a primer layer which allows the tungsten coatings to be more strongly bonded to the substrate. This primer layer may be any type of appropriate component known by one with skill in the art and may depend on the type of substrate and on the composition of the tungsten coating.

In yet another embodiment, the tungsten carbide coating may comprise a metal binder to increase the strength of the bonding of the coating to the substrate and thus to provide additional durability of the coated layer.

The deposition of the tungsten carbide coatings may be done by any method known by one with skill in the art. Such methods may comprise the steps of: (1) roughening/polishing and cleaning the surface of the substrate to be coated so as to facilitate the attachment and bonding of the further coating thereon; (2) applying the tungsten carbide coating on the roughened/polished and cleaned surface.

In order to provide superior stick resistant properties, the surface to be coated may be polished prior to coating. The polishing may be a mechanical polishing using abrasive papers, for example alumina abrasive paper, having a grain increasingly fine or an electropolishing. It is, of course, understood that a higher luster surface requires additional polishing with a buffing wheel and medium buffing abrasive which adds some additional cost to the finished cookware. Thus, a compromise between added cost and added stick resistance may be made in a commercial setting. In various embodiments, the treated surface may have a surface roughness of less than about 0.5 μm (about 20 microinches). In one embodiment, the surface has a roughness of between about 0.05 and 0.25 μm (between 2 and 10 microinches). In another embodiment, the surface has a roughness between about 0.05 and 0.20 μm (between 2 and 8 microinches). In yet another embodiment, the surface has a roughness of between about 0.05 and 0.13 μm (between 2 and 5 microinches).

A high degree of surface cleanliness may be used prior to coating the substrate layer. The dirty areas would act as a mask and prevent adhesion of the tungsten carbide coating layer. The surfaces of the article of cookware which are going to be coated may be cleaned, washed, degreased and dried by any techniques known by one with skill in the art. In one embodiment, the surfaces to be coated may be cleaned by a detergent and rinsed with deionized water after polishing/buffing treatment. In another embodiment, they also may be further cleaned in an ultrasonic bath. In yet another embodiment, the parts to be coated may be cleaned with a plasma bombardment of an inert gas.

The tungsten carbide coatings may be applied by means of physical vapor deposition (PVD), chemical vapor deposition (CVD), by a roller coating techniques, electrodeposition, thermal spray, or by any other coating technique known by one skilled in the art.

Further, one skilled in the art would appreciate that by varying the composition of the reaction mixture and of the parameters of the process (temperature of the substrate, flow rate, total pressure in the reaction mixture, temperature of the gases supplied, etc.), it is possible to obtain a variety of coatings having varied properties, depending on the desired application.

When making deep drawn cooking articles, such as pots and certain pans, it may difficult to polish the entire interior cooking surface. In such circumstances, according to an embodiment of the present disclosure, the tungsten carbide coating may be applied to a polished and cleaned flat metal sheet prior to its formation into the desired shape of the article of cookware. Alternatively, the coating may be applied after the cookware material has been polished, cleaned, shaped into the particular configuration and cleaned again.

Further, in another embodiment, the tungsten carbide coating is applied after shaping of the metal into the configuration of the particular piece of cookware, but prior to formation of patterns of depressions and protruding regions on the surface.

In yet another embodiment of the present disclosure, the tungsten carbide coatings may be applied to selected surfaces of the cookware to achieve any desired appearance, simply by masking those surfaces which are not to be coated. These masking techniques are well-known in the coating art.

After the completion of the coating process, the coated cookware articles may, according to one embodiment of the present disclosure, be rinsed of excess materials by dipping them briefly in a rinsing bath containing for example deionized water or ethanol. In another embodiment, the coated articles may be cleaned by for example a machining cleaning or using an appropriate detergent.

In conclusion, tungsten carbide as described above, when applied as a surface coating to cookware, sauce pan, frying pan, stock pan, casserole or any other food preparation surfaces, offers: (a) a substantial resistance to sticking foods to the surface; (b) a scratch resistance to the cookware article; and (c) a relatively long service life.

Although such tungsten carbide coatings are applied to the inner cooking surface of cookware articles, it is also desirable to employ such coatings on the outer side walls and on the bottom surface, where the coating is still beneficial in that any food which adheres can be easily removed. In one embodiment, the inner surface of the side wall of the cookware article is coated with a tungsten carbide coating according to the present disclosure. In another embodiment, the outer surface of the side wall of the cookware article is coated with a tungsten carbide coating according to the present disclosure. In yet another embodiment of the present disclosure, the inner cooking surface of the cookware article is coated in a tungsten carbide coating, which extends also onto the inner and outer surfaces of the side wall of the article of cookware.

Further, it may be determined that the outer surface of the side wall of the article of cookware doesn't need to be polished to the high degree of smoothness required on the cook surface and on the inner surface of the side wall as stick resistance may not be as critical for the exterior of the cookware as it is for its interior.

While preferred embodiments of the invention have been herein described, it will be apparent to those skilled in the art that various modifications may be made in these embodiments without departing from the spirit of the present disclosure. Such modifications are all within the scope of this invention.

### EXAMPLES

The following experiments were aimed at measuring contact angles and deriving there from the critical surface tensions of various coatings on metallic substrates with a series of pure liquids in order to compare tungsten carbide coatings with other commercially available coatings.

These experiments were conducted on flat, non-porous samples of solids. Five plates were used for analysis: one uncoated highly polished tungsten carbide WC plate, three polymer coated plates labeled “TK-2”, “TK-7”, “TK-805”, commercially available from Tuboscope Pipeline Services (Houston, Tex.), and “Z”. For analysis, sample coupons (2.54 cm (1 inch) in width) were cut from the larger plates using a high-speed rotary cutting wheel so that each coated sample could be accommodated by the measurement apparatus.

Contact angles were measured for a range of solvents (see Table 1 below) of known surface tension (γ_{LV}) using an apparatus that digitally records the droplet image. In all cases, 10 μl droplets of a given solvent were deposited on the surface of the sample coupon at randomly selected locations and replicate measurements (n=6) of the contact angle were made on both the left- and right side of the droplet image (see Table 2a to c below).

TABLE 1
Solvent series corresponding surface tensions used to derive the
critical surface tension of sample coupons

| | Surface Tension γ_{LV} |
|---|---|
| Solvent | (mN/m at 20° C.) |
| Water | 72.8 |
| Glycerol | 64.0 |
| Ethylene Glycol | 47.7 |
| PEG-200 | 43.5 |
| Decanol | 28.5 |
| Cyclohexanone | 34.6 |
| Diiodomethane | 50.8 |
| Formamide | 58.2 |

TABLE 2
Contact angles measured for Tungsten Carbide samples for development of Zisman plots (all angles are in degrees)

| | Tungsten Carbide | | | | | |
|---|---|---|---|---|---|---|
| | Angle | Angle | Angle | Angle | Angle | Angle |
| Solvent | 1 | 2 | 3 | 4 | 5 | 6 |
| Water | 37.5 | 36.7 | 39.2 | 33.7 | | |
| Glycerol | 28.2 | 25.3 | 24.7 | 25.8 | | |
| Ethylene | 34.4 | 29.4 | 28.3 | 25.8 | 29.9 | 27.3 |
| Glycol | | | | | | |
| PEG-200 | 22.4 | 21.1 | 20.3 | 20.7 | 21.9 | 20.7 |
| Decanol | 10.7 | 8.9 | 7.4 | 9.4 | | |
| Cyclohexanone | 5.1 | 4.3 | 3.3 | 2.7 | | |
| Diiodomethane | | | | | | |
| Formamide | | | | | | |

Contact angles measured for TK-2 and TK-7 samples for development of Zisman plots
(all angles are in degrees)

| | TK-2 | | | | | | TK-7 | | | | | |
|---|---|---|---|---|---|---|---|---|---|---|---|---|
| | Angle | Angle | Angle | Angle | Angle | Angle | Angle | Angle | Angle | Angle | Angle | Angle |
| Solvent | 1 | 2 | 3 | 4 | 5 | 6 | 1 | 2 | 3 | 4 | 5 | 6 |
| Water | 76.7 | 75.9 | 71.7 | 76.1 | 74.4 | 75.6 | 74.1 | 74.6 | 72.9 | 73.2 | 72.1 | 72.3 |
| Glycerol | 52.9 | 53.4 | 57.4 | 54.9 | 56.6 | 56.4 | 56.8 | 56.6 | 56.4 | 56.8 | | |
| Ethylene | 55.7 | 55.9 | 52.5 | 54.4 | 54.9 | 54.8 | 38.8 | 38.6 | 37.8 | 38.7 | | |
| Glycol | | | | | | | | | | | | |
| PEG-200 | 30.8 | 31.6 | 29.5 | 25.7 | 29.6 | 30.2 | 12.7 | 12.3 | 11.7 | 11.8 | | |
| Decanol | | | | | | | | | | | | |
| Cyclohexanone | 6.8 | 7 | 7.6 | 7.3 | | | | | | | | |
| Diiodomethane | 37.6 | 37.3 | 36.9 | 37.4 | | | 42.4 | 43.1 | 46.9 | 46.7 | | |
| Formamide | 47.6 | 46.9 | 47.2 | 47 | | | | | | | | |

Contact angles measured for TK-805 and surface “Z” samples for development of Zisman plots
(all angles are in degrees)

| | TK-805 | | | | | | Surface “Z” | | | | | |
|---|---|---|---|---|---|---|---|---|---|---|---|---|
| | Angle | Angle | Angle | Angle | Angle | Angle | Angle | Angle | Angle | Angle | Angle | Angle |
| Solvent | 1 | 2 | 3 | 4 | 5 | 6 | 1 | 2 | 3 | 4 | 5 | 6 |
| Water | 68.2 | 62.1 | 63.9 | 70.2 | 65.9 | 68.2 | 36.1 | 37.2 | 37.9 | 38.1 | | |
| Glycerol | | | | | | | 38.5 | 39.2 | 40.8 | 38.8 | | |
| Ethylene | | | | | | | 34.2 | 34.9 | 36.7 | 37.2 | | |
| Glycol | | | | | | | | | | | | |
| PEG-200 | 23.1 | 23.8 | 23.9 | 24.1 | | | 22.7 | 22.4 | 21.4 | 22.2 | | |
| Decanol | 7.1 | 6.4 | | | | | 12.1 | 11.8 | 11.7 | 11.5 | | |
| Cyclohexanone | 5.1 | 5.4 | | | | | | | | | | |
| Diiodomethane | 49.2 | 49.8 | 48.9 | 49.4 | | | 37.6 | 37.5 | 37.4 | 37.9 | | |
| Formamide | 36.7 | 37.5 | 36.9 | 37 | | | | | | | | |

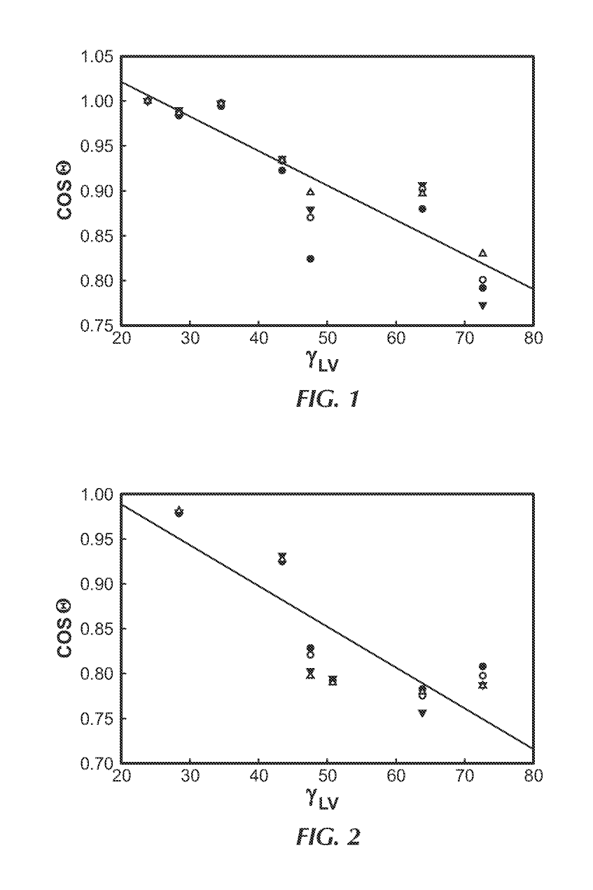

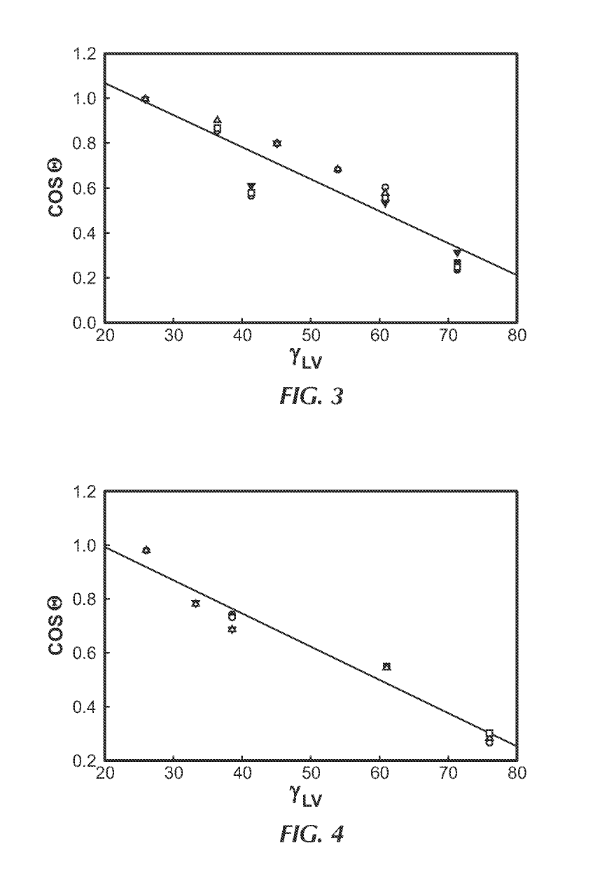

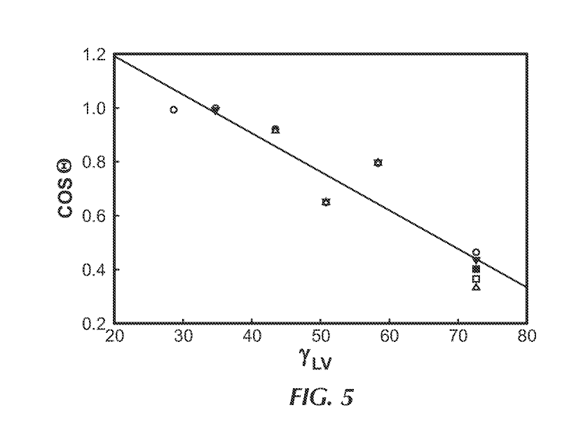

The critical surface tension was determined for each surface by the method of Zisman. In this method, the relationship between the known surface tension (γ_{LV}) of a series of solvents and the cosine of the measured contact angle (cos θ) is linearly extrapolated to cos θ=1 (see FIGS. 1 to 5—all γ_{LV} are in mN/m), where then the surface tension at this value is equivalent to the critical surface tension (γ_{c}) of the surface (see Table 3 below).

TABLE 3
Critical surface tensions determined from linear
extrapolation of Zisman plots

| | | Critical Surface |
|---|---|---|
| Surface | r² | Tension (γ_{c}, mN/m) |
| Tungsten | 0.8039 | 25.7 |
| Carbide | | |
| Z | 0.6871 | 17.3 |
| TK-2 | 0.8009 | 33.3 |
| TK-7 | 0.9580 | 39.5 |
| TK-805 | 0.8503 | 33.6 |

Advantageously, embodiments of the present disclosure may provide for one or more of the following. Tungsten carbide, when applied as a surface coating to cookware, sauce pan, frying pan, stock pan, casserole or any other food preparation surfaces, may offer (a) a substantial resistance to sticking foods to the surface; (b) a scratch resistance to the cookware article; and (c) a relatively long service life. Further, such coatings may be heat, corrosion, and/or oxidation resistant. Additionally, while providing a surface energy (and non-sticking) similar to polytetrafluoroethylene coatings conventionally used in coating cookware, the tungsten carbide coatings may provide an alternative with similar expected properties.

### Illustrative Embodiments

In one embodiment, there is disclosed a non-stick cookware apparatus, comprising a cookware article comprising a first material; a coating on the cookware article comprising a second material; wherein the second material comprises a critical surface tension value less than 75 mN/m and a hardness value of at least 5 measured on a Moh's scale. In some embodiments, the second material comprises a critical surface tension value less than 50 mN/m. In some embodiments, the second material comprises a critical surface tension value less than 25 mN/m. In some embodiments, the second material comprises a hardness value of at least 7 measured on a Moh's scale. In some embodiments, the second material comprises a hardness value of at least 8 measured on a Moh's scale. In some embodiments, the first material is selected from the group consisting of steel, stainless steel, cast iron, copper, and glass. In some embodiments, the second material comprises a carbide. In some embodiments, the second material comprises tungsten carbide. In some embodiments, the cookware article comprises a pot or a pan. In some embodiments, the cookware article comprises a pot or a pan, and wherein the coating is on an inner surface of the cookware article.

Those of skill in the art will appreciate that many modifications and variations are possible in terms of the disclosed embodiments of the invention, configurations, materials and methods without departing from their spirit and scope. Accordingly, the scope of the claims appended hereafter and their functional equivalents should not be limited by particular embodiments described and illustrated herein, as these are merely exemplary in nature.

1. A non-stick cookware apparatus, comprising:
a cookware article comprising a first material;
a coating on the cookware article comprising a second material;
wherein the second material comprises a critical surface tension value less than 75 mN/m and a hardness value of at least 5 measured on a Moh's scale.

2. The apparatus of claim 1, wherein the second material comprises a critical surface tension value less than 50 mN/m.

3. The apparatus of claim 1, wherein the second material comprises a critical surface tension value less than 25 mN/m.

4. The apparatus of claim 1, wherein the second material comprises a hardness value of at least 7 measured on a Moh's scale.

5. The apparatus of claim 1, wherein the second material comprises a hardness value of at least 8 measured on a Moh's scale.

6. The apparatus of claim 1, wherein the first material is selected from the group consisting of steel, stainless steel, cast iron, copper, and glass.

7. The apparatus of claim 1, wherein the second material comprises a carbide.

8. The apparatus of claim 1, wherein the second material comprises tungsten carbide.

9. The apparatus of claim 1, wherein the cookware article comprises a pot or a pan.

10. The apparatus of claim 1, wherein the cookware article comprises a pot or a pan, and wherein the coating is on an inner surface of the cookware article.
